(19) United States
(12) Patent Application Publication
(10) Pub. No.: US 2009/0280958 A1
(43) Pub. Date: Nov. 12, 2009

(54) SHIFT CONTROL SYSTEM FOR AUTOMATIC TRANSMISSION AND METHOD THEREOF

(75) Inventors: Dokyung Yim, Seoul (KR); Joung Chul Kim, Suwon- City (KR)

Correspondence Address: MORGAN, LEWIS & BOCKIUS LLP (SF), One Market, Spear Street Tower, Suite 2800, San Francisco, CA, 94105, US

(73) Assignees: HYUNDAI MOTOR COMPANY, Seoul (KR); KIA MOTORS CORPORATION, Seoul (KR)

(21) Appl. No.: 12/275,013

(22) Filed: Nov. 20, 2008

(30) Foreign Application Priority Data
May 9, 2008 (KR) 10-2008-0043463

(51) Int. Cl. F16H 59/20; B60W 10/10

(52) U.S. Cl. 477/115; 477/136

(57) ABSTRACT

A shift control system for an automatic transmission may include: a shift speed detector for detecting a current shift speed; a kick-down switch for detecting demand for a kick-down shift; and a control portion completing a shift to a target shift speed according to a predetermined shift pattern before a shift finish point by modifying control duties of off-going and on-coming elements if a shift pattern of a lower shift speed, a gear ratio of which is higher than that of the target shift speed, is passed during the kick-down shift, and then performing a shift to the lower shift speed.

### CROSS-REFERENCE TO RELATED APPLICATION

The present application claims priority to Korean Patent Application No. 10-2008-0043463 filed May 9, 2008, the entire contents of are incorporated herein for all purposes by this reference.

### BACKGROUND OF THE INVENTION

1. Field of the Invention

The present invention relates to an automatic transmission, and more particularly, to a shift control system for an automatic transmission and a method thereof that improves shift responsiveness by modifying control duties of off-going and on-coming elements at a target shift speed and a lower shift speed in a case in which a shift pattern of the lower shift speed, a gear ratio of which is higher than that of the target shift speed, is passed during a kick-down shift.

2. Description of Related Art

An automatic transmission controls hydraulic pressure by operating a plurality of actuators according to a vehicle speed and an opening of a throttle valve, such that a shift to a target shift speed is automatically performed.

In a case in which the shift to the target shift speed is performed, an automatic transmission has an off-going element that changes from an engaged state to a released state and an on-coming element that changes from a released state to an engaged state. Releasing an off-going element and engaging an on-coming element is realized by controlling hydraulic pressure supplied to respective elements.

In a case in which a large amount of torque is quickly needed such that a vehicle passes another vehicle or climbs a hill, an automatic transmission provides a kick-down shift (power-on down shift) in which a shift to a shift speed that is one N-1 or two N-2 steps lower than a current shift speed N is performed.

Generally, since a shift pattern in a 6-speed automatic transmission is set more densely than in a 4-speed automatic transmission or a 5-speed automatic transmission, passing a shift pattern of a lower shift speed, a gear ratio of which is higher than that of a target shift speed, in a case of a kick-down shift, frequently occurs.

For example, even if a kick-down shift is performed in a state in which a vehicle drives at a sixth forward speed, passing a 5→4 shift pattern while performing a 6→5 shift frequently occurs.

At this time, two shifts are sequentially performed according to a conventional automatic transmission.

For example, if a 5→4 shift pattern is passed during a kick-down shift (6→5 shift), a 5→4 shift is begun after a 6→5 shift is completed.

However, shift responsiveness and shift feel may be deteriorated according to such a sequential shift.

The above information disclosed in this Background section is only for enhancement of understanding of the background of the invention and therefore it may contain information that does not form the prior art that is already known in this country to a person of ordinary skill in the art.

### BRIEF SUMMARY OF THE INVENTION

Various aspects of the present invention are directed to provide a shift control system for an automatic transmission and a method thereof having advantages of improving shift responsiveness by modifying control duties of off-going and on-coming elements at a target shift speed and a lower shift speed in a case in which a shift pattern of the lower shift speed, a gear ratio of which is higher than that of the target shift speed, is passed during a kick-down shift.

A shift control system for an automatic transmission according to an aspect of the present invention may include a shift speed detector for detecting a current shift speed, a kick-down switch for detecting demand for a kick-down shift, and/or a control portion completing a shift to a target shift speed according to a predetermined shift pattern before a shift finish point by modifying control duties of off-going and on-coming elements if a shift pattern of a lower shift speed, a gear ratio of which is higher than that of the target shift speed, is passed during the kick-down shift, and then performing a shift to the lower shift speed according to the modified control duties of off-going and on-coming elements.

The kick-down switch is operated by an accelerator pedal.

The shift control system may further include a vehicle speed detector to detect a vehicle speed.

The shift control system may further include a throttle opening detector to detect opening of a throttle valve.

The predetermined shift pattern may be determined by a vehicle speed.

The predetermined shift pattern may be determined by a throttle opening.

The control portion may modify the control duties of the off-going and on-coming elements at the target shift speed and the lower shift speed according to turbine speed and turbine torque respective shift speeds.

In another aspect of the present invention, a shift control method for an automatic transmission, may include determining whether demand for a kick-down shift is detected, determining a target shift speed by applying a predetermined shift pattern, performing a shift to the target shift speed, determining whether a shift pattern of a lower shift speed, a gear ratio of which is higher than that of the target shift speed, is passed during the kick-down shift, modifying control duties of off-going and on-coming elements with compensation values if the shift pattern of the lower shift speed is passed, completing a shift to the target shift speed before a shift finish point according to the modified control duties of the off-going and on-coming elements, and/or performing a shift to the lower shift speed.

The predetermined shift pattern may be determined by a vehicle speed.

The predetermined shift pattern may be determined by a throttle opening.

The modification of the control duties of the off-going and on-coming elements may be performed respectively at the target shift speed and the lower shift speed.

The compensation values may be determined based on turbine speed and turbine torque respective shift speeds.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram of a shift control system for an automatic transmission according to an exemplary embodiment of the present invention.

FIG. 2 is a flowchart performing a kick-down shift control according to an exemplary embodiment of the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, only certain exemplary embodiments of the present invention have been shown and described, simply by way of illustration.

The present invention can be realized as various embodiments and cannot be limited to an exemplary embodiment described herein. Accordingly, the drawings and description are to be regarded as illustrative in nature and not restrictive.

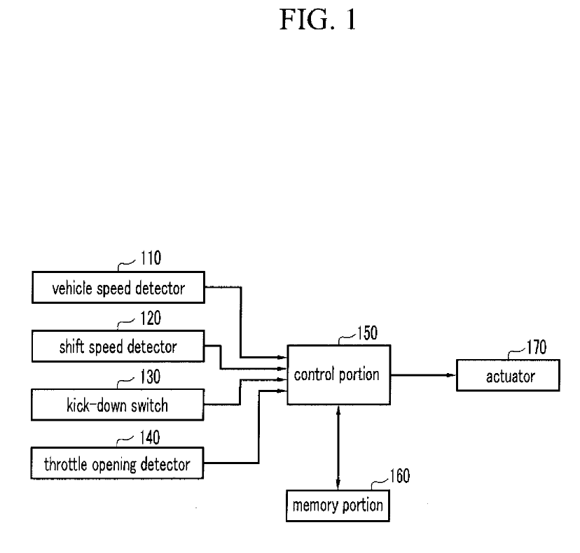

FIG. 1 is a block diagram of a shift control system for an automatic transmission according to an exemplary embodiment of the present invention.

As shown in FIG. 1, a shift control system for an automatic transmission according to an exemplary embodiment of the present invention includes a vehicle speed detector 110, a shift speed detector 120, a kick-down switch 130, a throttle opening detector 140, a control portion 150, a memory portion 160, and an actuator 170.

The vehicle speed detector 110 detects a vehicle speed by detecting a rotation speed of an output shaft of a transmission, and transmits information corresponding thereto to the control portion 150.

The shift speed detector 120 detects a currently synchronized shift speed, and transmits information corresponding thereto to the control portion 150.

The kick-down switch 130 is operated by an operation of an accelerator pedal, detects demand for a kick-down shift, and transmits information corresponding thereto to the control portion 150.

The throttle opening detector 140 detects opening of a throttle valve that is operated by the operation of the accelerator pedal, and transmits information corresponding thereto to the control portion 150.

When the demand for the kick-down shift is detected in a state in which a vehicle drives at any shift speed N, the control portion 150 determines a target shift speed that is one N-1 or two N-2 steps lower than a current shift speed N according to a predetermined shift pattern, and performs a shift to the target shift speed by controlling hydraulic pressures of off-going and on-coming elements.

In addition, if a shift pattern of a lower shift speed, a gear ratio of which is higher than that of the target shift speed, is passed during the shift to the target shift speed, the control portion 150 sets a flag of a sequential shift.

After that, the control portion 150 completes the shift to the target shift speed before a shift finish point by modifying control duties of the off-going and on-coming elements, and then performs a shift to the lower shift speed.

At this time, control duties of off-going and on-coming elements at the lower shift speed are also modified such that two sequential shifts are performed just as one shift is performed.

Various shift patterns according to the vehicle speed and the throttle opening and modifying factors according to various control condition of an engine are predetermined and stored in the memory portion 160 as a data table.

The actuator 170 is at least one of solenoid valves that are operated by a control signal of the control portion 150. The actuator 170 supplies hydraulic pressure to the on-coming element and exhausts hydraulic pressure from the off-going element during the shift.

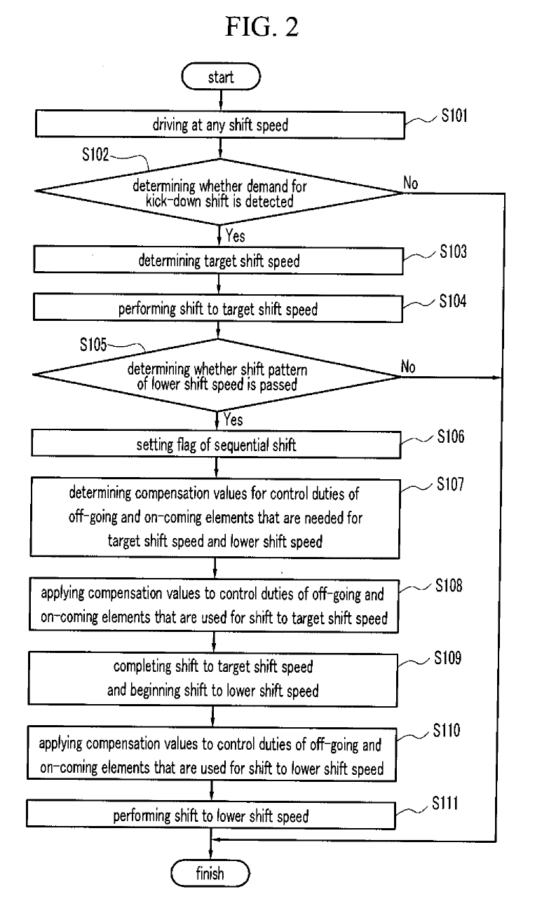

A shift control method for an automatic transmission according to an exemplary embodiment of the present invention will be described with reference to FIG. 2.

In a state in which a vehicle drives at any shift speed corresponding to driving conditions at step S1 01, the control portion 150 determines whether the demand for the kick-down shift is detected by the kick-down switch 130 at step S102.

If the demand for the kick-down shift is detected at step S 102, the control portion 150 determines the target shift speed (N-1 shift speed or N-2 shift speed) by applying a predetermined shift pattern stored in the memory portion 160 at step S103.

In addition, the control portion 150 performs the shift to the target shift speed by driving the actuator 170 to exhaust hydraulic pressure supplied to the off-going element and to supply hydraulic pressure to the on-coming element at step S104.

The control portion 150 determines at step S105 whether the shift pattern of the lower shift speed, a gear ratio of which is higher than that of the target shift speed, is passed during the shift to the target shift speed.

If the control portion 150 determines at step SI 05 that the shift pattern of the lower shift speed is passed, the control portion 150 sets the flag of the sequential shift at step S106 and determines compensation values for the control duties of the off-going and on-coming elements that are needed for the target shift speed and the lower shift speed at step S107.

The compensation values for the control duties of the off-going and on-coming elements are calculated and determined according to the turbine speed and the turbine torque at respective shift speeds, and the data table corresponding thereto is stored in the memory portion 160.

After that, the compensation values are applied to the control duties of the off-going and on-coming elements that are used for the shift to the target shift speed at step S108, the shift to the target shift speed is completed before the shift finish point, and the shift to the lower shift speed is begun at step S109.

As the shift to the lower shift speed has begun, the compensation values determined at step S107 are applied to the control duties of the off-going and on-coming elements that are used for the shift to the lower shift speed at step S110, and the shift to the lower shift speed is performed at step S111.

The method will hereinafter be exemplarily shown.

In a state in which a vehicle drives at a sixth forward speed, the control portion 150 performs a 6→5 shift when the demand for the kick-down shift is detected. If a 5→4 shift pattern is passed in a state in which the shift to the target shift speed is performed, the control portion 150 sets the flag of the sequential shift. After that, the control portion 150 modifies the control duties of the off-going and on-coming elements for the shift to a fifth forward speed that is the target shift speed and advances completion of the 6→5 shift. In addition, the control portion 150 begins a 5→4 shift.

If the 5→4 shift has begun, the control portion 150 modifies the control duties of the off-going and on-coming elements for the shift to a fourth forward speed and quickly performs the shift to the fourth forward speed that is the final shift speed.

As described above, when a sequential shift is needed at a kick-down shift, shift feel and shift responsiveness may be improved according to the present invention.

While this invention is described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For convenience in explanation and accurate definition in the appended claims, the term “lower” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shift control system for an automatic transmission, comprising:
a shift speed detector for detecting a current shift speed;
a kick-down switch for detecting demand for a kick-down shift; and
a control portion completing a shift to a target shift speed according to a predetermined shift pattern before a shift finish point by modifying control duties of off-going and on-coming elements if a shift pattern of a lower shift speed, a gear ratio of which is higher than that of the target shift speed, is passed during the kick-down shift, and then performing a shift to the lower shift speed according to the modified control duties of off-going and on-coming elements.

2. The shift control system of claim 1, wherein the kick-down switch is operated by an accelerator pedal.

3. The shift control system of claim 1, further comprising a vehicle speed detector to detect a vehicle speed.

4. The shift control system of claim 1, further comprising a throttle opening detector to detect opening of a throttle valve.

5. The shift control system of claim 1, wherein the predetermined shift pattern is determined by a vehicle speed.

6. The shift control system of claim 1, wherein the predetermined shift pattern is determined by a throttle opening.

7. The shift control system of claim 1, wherein the control portion modifies the control duties of the off-going and on-coming elements at the target shift speed and the lower shift speed according to turbine speed and turbine torque respective shift speeds.

8. An automatic transmission comprising the shift control system of claim 1.

9. A passenger vehicle comprising the shift control system of claim 1.

10. A shift control method for an automatic transmission, comprising
determining whether demand for a kick-down shift is detected;
determining a target shift speed by applying a predetermined shift pattern;
performing a shift to the target shift speed;
determining whether a shift pattern of a lower shift speed, a gear ratio of which is higher than that of the target shift speed, is passed during the kick-down shift;
modifying control duties of off-going and on-coming elements with compensation values if the shift pattern of the lower shift speed is passed;
completing a shift to the target shift speed before a shift finish point according to the modified control duties of the off-going and on-coming elements; and
performing a shift to the lower shift speed.

11. The shift control system of claim 10, wherein the predetermined shift pattern is determined by a vehicle speed.

12. The shift control system of claim 10, wherein the predetermined shift pattern is determined by a throttle opening.

13. The shift control method of claim 10, wherein the modification of the control duties of the off-going and on-coming elements is performed respectively at the target shift speed and the lower shift speed.

14. The shift control method of claim 10, wherein the compensation values are determined based on turbine speed and turbine torque respective shift speeds.

15. A shift control system for an automatic transmission, comprising:
a shift speed detector for detecting a current shift speed;
a kick-down switch operated by an accelerator pedal and detecting demand upshift or downshift more than two speed steps; and
a control portion completing a shift to a target shift speed according to a predetermined shift pattern before a shift finish point by modifying control duties of off-going and on-coming elements if a shift pattern of a lower shift speed, a gear ratio of which is higher than that of the target shift speed, is passed during the kick-down shift, and then performing a shift to the lower shift speed according to the modified control duties of off-going and on-coming elements.
